(19) United States
(12) Patent Application Publication
(10) Pub. No.: US 2016/0311192 A1
(43) Pub. Date: Oct. 27, 2016

(54) ANTI-SLIP PAD

(71) Applicants: Sandeep Yadav, Decatur, GA (US); Tamera Scholz, Irvine, CA (US)

(72) Inventors: Sandeep Yadav, Decatur, GA (US); Tamera Scholz, Irvine, CA (US)

(21) Appl. No.: 15/139,965

(22) Filed: Apr. 27, 2016

Related U.S. Application Data
(60) Provisional application No. 62/153,090, filed on Apr. 27, 2015.

(51) Int. Cl. B32B 3/14; B32B 3/30; B32B 7/12

(52) U.S. Cl. CPC B32B 3/14; B32B 7/12; B32B 3/30; B32B 2274/00; B32B 2307/744; B32B 2457/00

(57) ABSTRACT

Various implementations include an anti-slip pad for use with a portable electronic device. The anti-slip pad may prevent the portable electronic device from slipping out of the user's hand or across a surface, for example. As described below, the pad includes a non-slip layer and an adhesive layer that are permanently affixed to each other. The non-slip layer has a first side and a second side opposite the first side. The first side of the non-slip layer has a non-slip surface. The adhesive layer is affixed to the second side of the non-slip layer. The adhesive layer is configured for being removably adherable to an outer surface of the portable electronic device such that the non-slip layer faces away from the outer surface. The adhesive layer allows the pad to be selectively repositioned on the portable electronic device, according to some implementations.

### CROSS-REFERENCE TO RELATED APPLICATION

This application claims priority to U.S. Provisional Application Number 62/153,090, entitled “Anti-Slip Pad,” filed Apr. 27, 2015, the content of which is herein incorporated by reference in its entirety.

### BRIEF SUMMARY

According to various implementations, an anti-slip pad is provided for use with a portable electronic device. The pad includes a non-slip layer having a first side and a second side opposite the first side. The first side has a non-slip surface. The pad also includes at least one adhesive layer disposed adjacent the second side of the non-slip layer. The adhesive layer is removably adherable to an outer surface of the portable electronic device such that the non-slip layer faces away from the outer surface, and the anti-slip pad is divided into a plurality of portions that are separable from each other. At least two of the portions have a different shape or size.

In some implementations, the plurality of portions include shapes of a tangram puzzle. In some implementations, the plurality of portions includes shapes that form a first design when disposed adjacent each other in a first arrangement and a second design when disposed adjacent each other in a second arrangement, wherein the first design is different from the second design.

In some implementations, a coefficient of friction of the non-slip layer is between about 2 and about 3.

In some implementations, the first side of the non-slip layer includes a textured thermoplastic elastomer. For example, the textured thermoplastic elastomer may be rolled.

In some implementations, the non-slip layer has a thickness of between about 0.005 inches to about 0.01 inches, wherein the thickness is measured from the first side and the second side.

In some implementations, the non-slip layer is flexible.

In some implementations, the adhesive layer is pressure sensitive.

In some implementations, the adhesive layer includes a first adhesive layer that is removably adherable to the outer surface of the portable electronic device and a second adhesive layer disposed between the first adhesive layer and the second side of the non-slip layer.

In some implementations, the non-slip surface includes an array of hair-like extensions that extend upwardly from the non-slip layer.

In various other implementations, an anti-slip pad for use with a portable electronic device is provided that includes a non-slip layer having a first side and a second side opposite the first side, wherein the first side has a non-slip surface. The pad also includes an adhesive layer disposed on the second side of the non-slip layer. The adhesive layer is removably adherable to an outer surface of the portable electronic device such that the non-slip layer faces away from the outer surface, and the anti-slip pad is elliptically shaped.

### BRIEF DESCRIPTION OF THE DRAWINGS

The device is explained in even greater detail in the following exemplary drawings. The drawings are merely exemplary to illustrate the structure of preferred devices and certain features that may be used singularly or in combination with other features. The invention should not be limited to the implementations shown.

FIG. 1A illustrates a perspective side view of an anti-slip pad according to various implementations.

FIG. 1B illustrates a side view of a pad having an array of hair-like extensions that extend upwardly from a first side of the pad according to various implementations.

FIG. 1C illustrates a top view of the pad in FIG. 1B.

FIG. 2 illustrates two anti-slip pads adhered to a back surface of a portable electronic device according to one implementation.

FIG. 3 illustrates one anti-slip pad having an elliptical shape adhered to a back surface of a portable electronic device according to one implementation.

FIG. 4 illustrates an anti-slip pad cut into shapes in a tangram puzzle according to one implementation.

FIG. 5 illustrates a design created using the tangram puzzle shapes shown in FIG. 4 when adhered to a back surface of a portable electronic device, according to one implementation.

FIG. 6 illustrates a perspective side view of an anti-slip pad according to another implementation.

### DETAILED DESCRIPTION

Various implementations include an anti-slip pad for use with a portable electronic device. The anti-slip pad may prevent the portable electronic device from slipping out of the user's hand or across a surface, for example. As described below, the pad includes a non-slip layer and an adhesive layer that are permanently affixed to each other. The non-slip layer has a first side and a second side opposite the first side. The first side of the non-slip layer has a non-slip surface. The adhesive layer is affixed to the second side of the non-slip layer. The adhesive layer is configured for being removably adherable to an outer surface of the portable electronic device such that the non-slip layer faces away from the outer surface. The adhesive layer allows the pad to be selectively repositioned on the portable electronic device, according to some implementations.

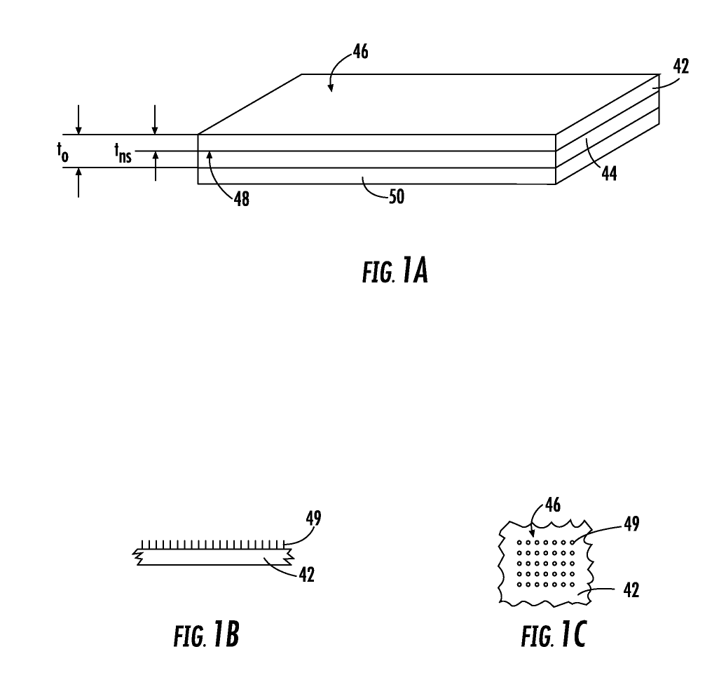

As shown in FIG. 1A, the anti-slip pad 40 according to one implementation includes non-slip layer 42 and adhesive layer 44. The non-slip layer 42 has a first side 46 and a second side 48 opposite the first side 46. The thickness tₙₛ of the non-slip layer 42 as measured between the first 46 and second sides 48 is between about 0.005 to about 0.01 inches thick. The overall thickness tₒ of the non-slip layer 42 and the adhesive layer 44 is between about 0.025 to about 0.1 inches thick. These thickness ranges are exemplary, and in other implementations, the thickness ranges may be larger or smaller.

The first side 46 of the non-slip layer 42 has a coefficient of friction between about 2 to about 3 (dry and wet). For example, the coefficient of friction of the non-slip layer 42 in one implementation is about 2.6 wet and about 2.8 dry. Various types of materials may be used for the non-slip layer 42, such as a thermoplastic elastomer, rubber, leather, or other synthetic or natural material having a sufficient coefficient of friction, for example. In addition, the non-slip layer 42 may be flexible. Exemplary types of materials that may be used for the non-slip layer 42 include, but are not limited to, gripping materials manufactured by 3M, such as GM614, GM631, or GM641. For example, GM614, which has a shore A hardness of about 15 and a dry coefficient of friction of about 2.6 and a wet coefficient of friction of about 2.8 as measured using ASTMD-1842, may be well suited for some implementations. GM631 has a shore A hardness of about 30 and a dry coefficient of friction of about 3.0 and a wet coefficient of friction of about 3.3. GM641 has a shore A hardness of about 40 and a dry coefficient of friction of about 3.4 and a wet coefficient of friction of about 3.5. GM614, GM631, and GM641 have adhesive on one side of them. However, GM613, GM630, and GM640 have similar specifications as GM614, GM631, and GM641, respectively, but do not include an adhesive layer. All six gripping materials may be used according to various implementations.

In certain implementations, the material for the non-slip layer 42 is extruded and rolled on the first side 46 to create a textured surface on the first side 46. The non-slip layer 42 may be formed by injection or compression molding or other suitable manufacturing methods, according to other implementations.

As shown in the implementation shown in FIGS. 1B and 1C, the first side 46 may include an array of hair-like extensions 48 that extend upwardly from the first side 46. These hair-like extensions 48 provide a soft, non-slip tactile feel to the user. In other implementations (not shown), the first side 46 may include a plurality of indentations to provide the textured surface.

Furthermore, the non-slip layer 42 may be abrasion resistant and puncture resistant.

The adhesive layer 44 may include any suitable adhesive, including, for example, various repositionable tapes. For example, 3M adhesive 9425 has been shown to work well for some implementations. In the implementation shown in FIG. 1A, the adhesive layer 44 is permanently secured to the non-slip layer 44, such as by rolling or laminating the adhesive onto the second side 48 of the non-slip layer 42 or other suitable manufacturing methods. The side of the adhesive layer 44 that is opposite the side that is permanently secured to the non-slip layer 44 is configured for removably adhering to the back surface of the portable electronic device in response to pressure from the user. In other words, the adhesive layer can be removed and repositioned on the back surface by the user with minimal effort by the user and with minimal or no adhesive residue. In another implementation, shown in FIG. 6, the adhesive layer 44 comprises two different adhesive layers 44a, 44b. Adhesive layer 44a is stronger than adhesive layer 44b and is disposed between the second side 48 of the non-slip pad 40 and adhesive layer 44b. Adhesive layer 44a prevents adhesive layer 44b from separating from the non-slip pad 40. Adhesive layer 44b may be removably adherable to the back surface of the portable electronic device. For example, adhesive layer 44a may include an acrylic pressure sensitive adhesive, and adhesive layer 44b may include a repositionable tape, such as a repositionable tape manufactured by 3M. Suitable repositionable tapes include those having medium tack (e.g., between about 12 to about 25 ounces/inch) on one side and high or permanent tack (e.g., at least about 45 ounces/inch) on the other (e.g., 3M's 9425 or 9425HT), low tack (e.g., less than about 5 ounces/inch) on one side and high or permanent tack (e.g., at least about 45 ounces/inch) on the other (e.g., 3M's 9415PC, 9416), medium tack (e.g., between about 12 to about 25 ounces/inch) on both sides (e.g., 3M's 665, 666), or low tack (e.g., less than about 5 ounces/inch) on both sides (e.g., 3M's 9449S). In some implementations, other types of adhesive may be selected, there may be more than two adhesive layers, and/or the outermost adhesive layer (furthest layer from the second side 48 of the non-slip pad 40) may not be selectively removed and repositioned on the portable electronic device.

As shown in FIG. 1A, prior to being disposed onto a portable electronic device, a backing layer 50 may be disposed on the adhesive layer 44 to prevent the adhesive layer 44 from adhering to another surface until the backing layer 50 is removed. The backing layer 50 may be paper or other suitable material, and the backing layer 50 may have a coating that prevents the adhesive layer 44 from sticking to the backing material.

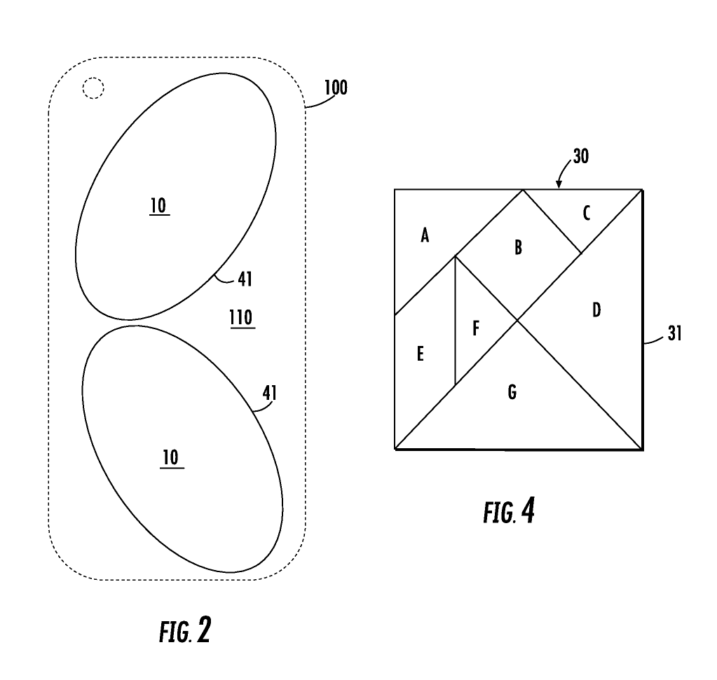

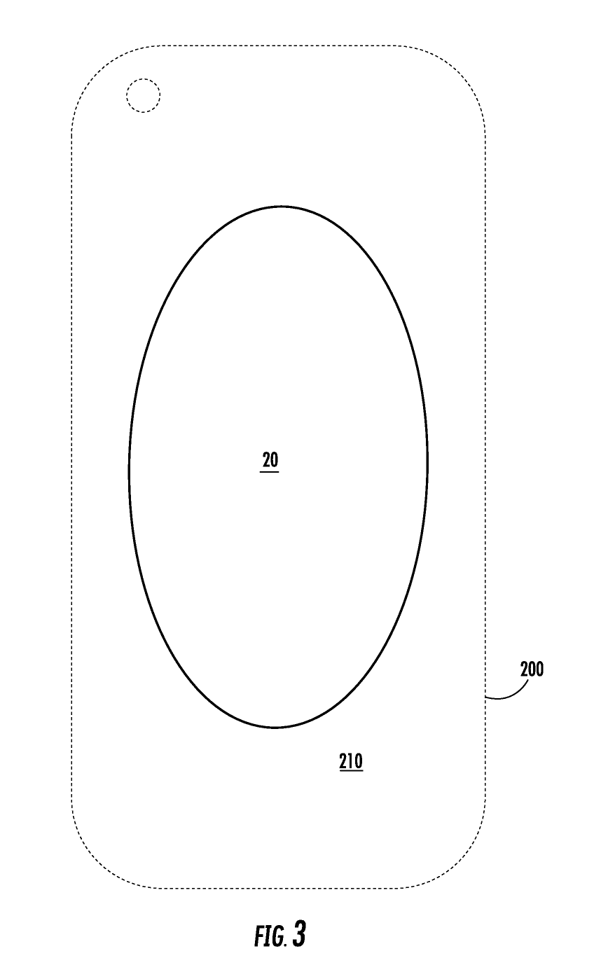

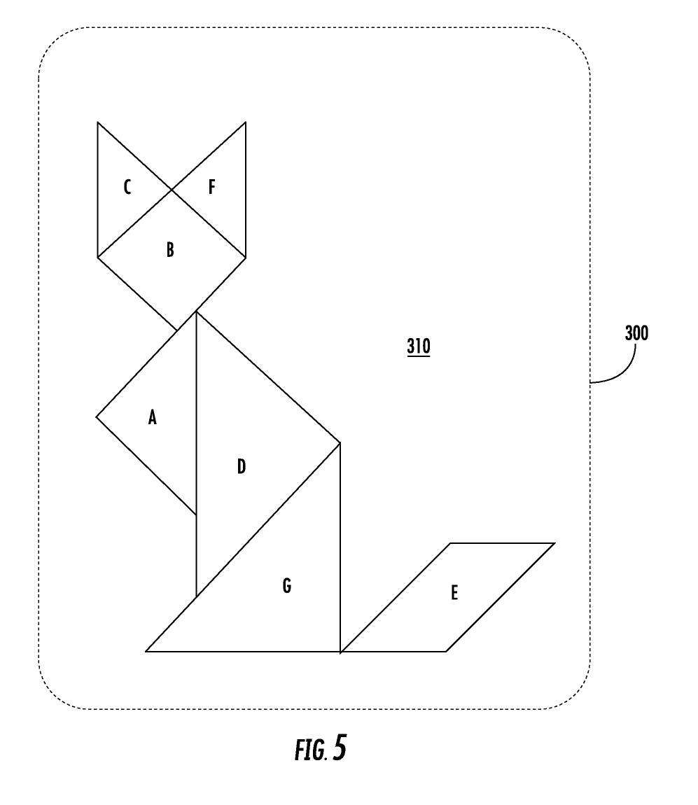

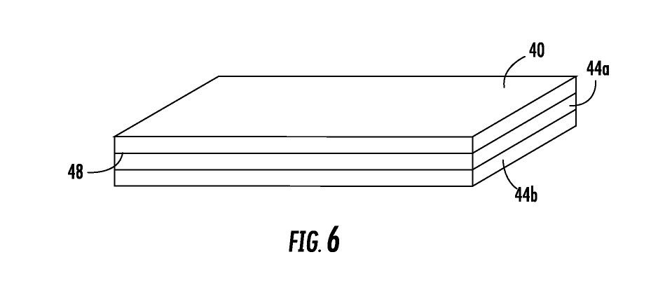

After the adhesive layer 44 is permanently secured to the non-slip layer 42, the outer perimeter of the pad may be die cut to the desired shape. Furthermore, if the pad is to include a plurality of separable portions, such as described below with respect to FIGS. 4 and 5, the separable portions may be die cut to their desired shapes. In some implementations, the separable portions may be “kiss cut,” which means that the portions are die cut through the non-slip layer 42 and adhesive layer 44 but not through the backing layer 50. Kiss cutting allows the portions to be packaged efficiently onto one backing paper and then arranged as desired by the user onto the back surface of the portable electronic device.

In other implementations (not shown), the pad may be molded into the desired shape(s) instead of die cut.

FIG. 2 illustrates an anti-slip pad 10 that has an elliptically shaped outer perimeter 41 adhered to a back surface 110 of a portable electronic device 100. The portable electronic device 100 shown in FIG. 2 is a cellular telephone, but in other implementations, it may be other types of portable electronic devices, such as tablets or handheld computing devices. FIG. 3 illustrates an elliptically shaped pad 20 that has a larger outer perimeter 61 than the outer perimeter 41 of pad 10. The pad 20 may be disposed on a portable electronic device 200 having a larger back surface than the portable electronic device 100 shown in FIG. 2, for example. According to certain implementations, the elliptical shaped edges of the pad prevent edges of the pad from peeling away from the portable electronic device unintentionally.

In other implementations, the outer perimeter of the pad may include other various shapes and sizes. And, the pad may be cut by the user into custom shapes. In addition, in some implementations, the pad may include a plurality of separable portions that are disposed in a spaced apart arrangement on the back surface of the portable electronic device and together form a suitable anti-slip surface.

FIGS. 4 and 5 illustrate an anti-slip pad 30 according to another implementation. The anti-slip pad 30 has a square shaped outer perimeter 31 and is cut into seven separate portions A-G within the outer perimeter 31. The portions A-G are pieces of a tangram puzzle and may be separated from each other and adhered to a back surface of a portable electronic device in any pattern selected by the user. For example, FIG. 5 illustrates the seven portions arranged into the shape of a fox onto the back surface 310 of portable electronic device 300.

While the foregoing description and drawings represent the various implementations of the present invention, it will be understood that various additions, modifications, combinations and/or substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. In addition, features described herein may be used singularly or in combination with other features. The presently disclosed implementations are, therefore, to be considered in all respects as illustrative and not restrictive, the scope of the invention being indicated by the appended claims and not limited to the foregoing description.

1. An anti-slip pad for use with a portable electronic device comprising:
a non-slip layer having a first side and a second side opposite the first side, the first side having a non-slip surface; and
at least one adhesive layer disposed adjacent the second side of the non-slip layer, wherein:
the adhesive layer is removably adherable to an outer surface of the portable electronic device such that the non-slip layer faces away from the outer surface, and
the anti-slip pad is divided into a plurality of portions that are separable from each other, and at least two of the portions have a different shape or size.

2. The anti-slip pad of claim 1, wherein the plurality of portions includes shapes of a tangram puzzle.

3. The anti-slip pad of claim 1, wherein the plurality of portions includes shapes that form a first design when disposed adjacent each other in a first arrangement and a second design when disposed adjacent each other in a second arrangement, wherein the first design is different from the second design.

4. The anti-slip pad of claim 1, wherein a coefficient of friction of the non-slip layer is between about 2 and about 4.

5. The anti-slip pad of claim 1, wherein the first side of the non-slip layer comprises a textured thermoplastic elastomer.

6. The anti-slip pad of claims 5, wherein the first side of the non-slip layer is rolled.

7. The anti-slip pad of claim 1, wherein the non-slip layer has a thickness of between about 0.005 inches to about 0.01 inches, wherein the thickness is measured from the first side and the second side.

8. The anti-slip pad of claim 1, wherein the non-slip layer is flexible.

9. The anti-slip pad of claim 1, wherein the adhesive layer is pressure sensitive.

10. The anti-slip pad of claim 1, wherein the adhesive layer comprises a first adhesive layer that is removably adherable to the outer surface of the portable electronic device and a second adhesive layer disposed between the first adhesive layer and the second side of the non-slip layer.

11. The anti-slip pad of claim 1, wherein the non-slip surface comprises an array of hair-like extensions that extend upwardly from the non-slip layer.

12. An anti-slip pad for use with a portable electronic device comprising:
a non-slip layer having a first side and a second side opposite the first side, the first side having a non-slip surface; and
an adhesive layer disposed on the second side of the non-slip layer, wherein:
the adhesive layer is removably adherable to an outer surface of the portable electronic device such that the non-slip layer faces away from the outer surface, and
the anti-slip pad is elliptically shaped.

13. The anti-slip pad of claim 12, wherein a coefficient of friction of the non-slip layer is between about 2 and about 4.

14. The anti-slip pad of claim 12, wherein the first side of the non-slip layer comprises a textured thermoplastic elastomer.

15. The anti-slip pad of claims 14, wherein the first side of the non-slip layer is rolled.

16. The anti-slip pad of claim 12, wherein the non-slip layer has a thickness of between about 0.005 to about 0.01 inches wherein the thickness is measured from the first side and the second side.

17. The anti-slip pad of claim 12, wherein the non-slip layer is flexible.

18. The anti-slip pad of claim 12, wherein the adhesive layer is pressure sensitive.

19. The anti-slip pad of claim 12, wherein the adhesive layer comprises a first adhesive layer that is removably adherable to the outer surface of the portable electronic device and a second adhesive layer disposed between the first adhesive layer and the second side of the non-slip layer.

20. The anti-slip pad of claim 12, wherein the non-slip surface comprises an array of hair-like extensions that extend upwardly from the non-slip layer.
